(19) United States
(12) Patent Application Publication
(10) Pub. No.: US 2007/0113802 A1
(43) Pub. Date: May 24, 2007

(54) Piston for internal combustion engine

(76) Inventor: Kenji Mihara, Tochigi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/585,362

(22) PCT Filed: Dec. 27, 2004
(86) PCT No.: PCT/JP04/19504

§ 371 Date: Jul. 6, 2006

(30) Foreign Application Priority Data
Jan. 7, 2004 (JP) 2004-001901

(51) Int. Cl. F01P 1/04; F02F 3/00; F02F 1/00

(52) U.S. Cl. 123/41.35; 123/254; 123/193.6

(57) ABSTRACT

Surface roughnesses of a rear surface 10a of a combustion chamber 10 and an inner wall 11a of a cooling cavity 11 of a piston 1 are equal to or less than 6.3 S (areas a′ and b′ indicated by chain double-dashed lines). The areas of which surface roughness is equal to or less than 6.3 S are surface-coated with a layer of a self-cleaning catalyst. Accordingly, the oil is less subject to remain on the surface-coated areas, so that oil coking and a decrease in the coefficient of heat transfer can be avoided, thereby preventing an increase in temperature and deterioration in strength of the piston caused by coking. Therefore, the piston 1, 30 for an internal combustion engine which has a simple structure to be compact and to avoid an increase in cost and easily responds to increased engine power without increasing an amount of the cooling oil and the capacity of an oil cooler can be obtained.

### TECHNICAL FIELD

The present invention relates to a piston for an internal combustion engine and more particularly to a device for improving the cooling capability of a piston employed in a high-speed and high-power diesel engine having a piston-cooling system using engine oil.

### BACKGROUND ART

As a conventional piston-cooling system provided in the high-power diesel engine, a piston-cooling system for an internal combustion engine disclosed in Patent Document 1 can be exemplified.

FIG. 1 is a side cross section showing an arrangement of a piston for an internal combustion engine and the piston-cooling system disclosed in Patent Document 1, and FIG. 2 is a view when seen in the direction of arrow X of FIG. 1. FIG. 1 is also a view taken along A-A line and seen in the direction of arrows A of FIG. 2.

In FIGS. 1 and 2, a piston 1, which is a first prior art example, is formed by casting (e.g. FCD: spheroidal graphite cast iron). On a top surface 2 of the piston 1, a recessed combustion chamber 10 that is upwardly open is provided, and a circular cooling cavity 11 is provided between the combustion chamber 10 and an upper peripheral portion 3 of the piston 1, the upper peripheral portion 3 having piston ring grooves 4.

The cooling cavity 11 has an intake port 12 and an outlet port 13 located about 90 to 180 degrees apart from the intake port 12, both being substantially orthogonal to the cooling cavity 11 in an T-shape and in communication with a rear surface side of the piston 1. Also provided inside the piston 1 is a guide pipe 14 communicating the intake port 12 and a bottom end member 6 of a skirt 5 of the piston 1 and serving as a passage of cooling engine oil. In addition, at an upper portion of the guide pipe 14, an oil injection port 15 for injecting the cooling oil toward a rear surface 10a of the combustion chamber 10 is formed.

In a cylinder block (not shown) disposed below the piston 1, a cooling-oil-feeding passage 22 fed with the engine oil from an oil pump 21 is formed, the cooling-oil-feeding passage 22 being attached with a cooling nozzle 23 oriented to a bottom end member 14a of the guide pipe 14. The oil pump 21, the cooling-oil-feeding passage 22 and the cooling nozzle 23 constitute a cooling system 20.

Next, how to operate will be described.

In FIG. 1, the cooling engine oil is fed by pressure from the oil pump 21 through the cooling-oil-feeding passage 22 to the cooling nozzle 23. The engine oil injected from the cooling nozzle 23 to the bottom end member 14a of the guide pipe 14 ascends through the guide pipe 14, enters the cooling cavity 11 from the intake port 12 as indicated by the arrows and bifurcates right and left to cool an inner wall 11a of the cooling cavity 11, and then exits from the outlet port 13 into the cylinder block (not shown). Part of the engine oil that has ascended through the guide pipe 14 is injected to the rear surface 10a of the combustion chamber 10 from the oil injection port 15 as indicated by the arrows to cool the rear surface 10a and emitted into the cylinder block (not shown).

Thus, the engine oil injected toward the rear surface 10a of the combustion chamber 10 reliably cools the rear surface 10a of the combustion chamber 10 without being hindered by a connecting rod or a pin boss (not shown). A distance between an exit of the cooling nozzle 23 and the bottom end member 14a of the guide pipe 14 is sufficiently narrow, so that the capture rate of the engine oil can be improved to reduce an amount of the cooling oil. In addition, since only one cooling nozzle 23 is required, the structure can be simple and the cost can be reduced. Consequently, the piston is allegedly preferable for the high-speed and high-power engine.

FIG. 3 is a side cross section of an articulated piston 30, which is a second prior art example.

In FIG. 3, the articulated piston 30 includes a piston head 31 made of, e.g., forged iron and a piston skirt 40 made of, e.g., aluminum, and these components and a connecting rod 41 are swingably communicated to a piston pin 42. A peripheral portion 32 of the piston head 31 has a plurality of piston rings 33. Provided on a top surface 34 of the piston head 31 is a recessed combustion chamber 35 that is upwardly open, and a cooling groove 36 is provided between the peripheral portion 32 of the piston head 31 and the combustion chamber 35.

In the articulated piston 30, an oil gallery 41A communicating a large end portion 41D and a small end portion 41S of the connecting rod 41 is provided such that the oil is introduced from a crank pin 41C of the connecting rod 41 and led through the oil gallery 41A to the small end portion 41S of the connecting rod 41 to be injected from an hole 41H defined in an end of the small end portion 41S toward a rear surface 35a of the combustion chamber 35. The oil is also injected to an inner wall 36a of the cooling groove 36 by a cooling system employing a cooling nozzle and a guide pipe (not shown). Specifically, the cooling groove 36 is partitioned by a baffle plate 37 at a lower portion thereof, and the oil from the guide pipe is fed into the cooling groove 36 via an intake pipe 38 provided to the baffle plate 37. Thus, the same effects as those of the first prior art example can be attained.

[Patent Document 1] Japanese Patent Laid-Open publication No. Hei 11-132101 (pages 3 and 4, FIGS. 1 and 2)

### DISCLOSURE OF THE INVENTION

### Problems to be Solved by the Invention

However, the above-described arrangements contain following problems.

In FIG. 1, as mentioned above, while the engine is in operation, the cooling engine oil is fed to the cooling cavity 11 and the rear surface 10a of the combustion chamber 10 to cool a hot head portion of the piston 1. When the engine is stopped, the feeding of the engine oil is also stopped. Accordingly, when the engine is stopped, the cooling engine oil adhering to the piston 1 becomes hot.

The residual engine oil adhering areas that particularly become hot, i.e., areas a indicated by chain double-dashed lines of the inner wall 11a of the cooling cavity 11 and an area b indicated by a chain double-dashed line of the rear surface 10a of the combustion chamber 10 is carbonized and burnt off to cause coking. By repeating this, coking oil is accumulated in layers, so that the coefficient of heat transfer is decreased, causing poor cooling. Consequently, the areas that are not sufficiently cooled may become very hot, possibly triggering a decrease in strength and cracks. The higher engine power becomes, the higher the risk becomes. Additionally, the rougher the surfaces of the inner wall 11a and the rear surface 10a become, the more easily the coking oil adheres thereto to accumulate. The problem can be solved by increasing the amount of the cooling oil, but the increase requires, e.g., a larger oil pump or a larger capacity of an oil cooler for cooling the engine oil, thereby causing an increase in size and cost.

The same problem also occurs with the articulated piston 30 shown in FIG. 3. Concretely, the coking of oil is also produced at areas a and b indicated by chain double-dashed lines in FIG. 3.

The present invention is directed to overcome the problems described above, and an object of the invention is to provide a piston for an internal combustion engine, which can eliminate the risk of coking and accumulation of engine oil when the piston is cooled by the engine oil and can easily respond to increased engine power while having a simple structure to be compact and to avoid an increase in cost.

### MEANS FOR SOLVING THE PROBLEMS

A piston for an internal combustion engine according to claim 1 of the present invention is a piston cooled by oil. The piston includes: a combustion chamber that is formed in a recessed shape on a top surface of the piston and has a rear surface cooled by the oil; and a circular cooling cavity or a circular cooling groove which is provided on a peripheral portion of the combustion chamber, an inner wall of the cavity or the groove being cooled by the oil. A surface roughness of at least one of the rear surface of the combustion chamber, the inner wall of the cooling cavity and the inner wall of the cooling groove is equal to or less than 6.3 S.

A piston for an internal combustion engine according to claim 2 of the invention is a piston cooled by oil. The piston includes: a combustion chamber that is formed in a recessed shape on a top surface of the piston and has a rear surface cooled by the oil; and a circular cooling cavity or a circular cooling groove which is provided on a peripheral portion of the combustion chamber, an inner wall of the cavity or the groove being cooled by the oil. At least one of the rear surface of the combustion chamber, the inner wall of the cooling cavity and the inner wall of the cooling groove is surface-coated to prevent oil coking.

A piston for an internal combustion engine according to claim 4 of the invention is a piston cooled by oil. The piston includes: a combustion chamber that is formed in a recessed shape on a top surface of the piston and has a rear surface cooled by the oil; and a circular cooling cavity or a circular cooling groove which is provided on a peripheral portion of the combustion chamber, an inner wall of the cavity or the groove being cooled by the oil. A surface roughness of at least one of the rear surface of the combustion chamber, the inner wall of the cooling cavity and the inner wall of the cooling groove is equal to or less than 6.3 S. The at least one of the rear surface of the combustion chamber, the inner wall of the cooling cavity and the inner wall of the cooling groove is surface-coated to prevent oil coking.

The piston for an internal combustion engine according to claim 4 of the invention is the piston according to claim 2 or 3, of which surface coating is a thin layer of a self-cleaning catalyst.

The piston for an internal combustion engine according to claim 5 of the invention is the piston according to claim 2 or 3, of which surface coating is a thin layer of a porcelain enamel coating.

The piston for an internal combustion engine according to claim 6 is the piston according to claim 2 or 3, of which surface coating is a thin layer of a polysilazane silica coating.

### EFFECT OF THE INVENTION

As described above, according to an aspect of the invention of claim 1, the surface roughness of at least one of the cooling cavity, the cooling groove and the rear surface of the combustion chamber of the piston is equal to or less than 6.3 S. Hence, the oil is less subject to remain on the areas, eliminating oil coking and preventing a decrease in the coefficient of heat transfer to avoid an increase in temperature. Thereby, deterioration in strength of the piston caused by the coking can be prevented. Therefore, it is not necessary to increase the amount of the cooling oil and the capacity of an oil cooler as the engine output is increased, and the piston for an internal combustion engine which has a simple structure to be compact and to avoid an increase in cost and easily responds to an increase in engine power can be obtained.

Note that, the surface roughness is a roughness of a metal surface of the piston.

According to an aspect of the invention of claim 2, at least one of the cooling cavity, the cooling groove and the rear surface of the combustion chamber of the piston is surface-coated to prevent oil coking. Hence, the oil is less subject to remain on the areas, eliminating oil coking and preventing a decrease in the coefficient of heat transfer to avoid an increase in temperature. Thereby, deterioration in strength of the piston caused by the coking can be prevented. Therefore, the piston for an internal combustion engine which can easily respond to increased in engine power can be obtained at a low cost.

According to an aspect of the invention of claim 3, the surface roughness of at least one of the cooling cavity, the cooling groove and the rear surface of the combustion chamber of the piston is equal to or less than 6.3 S. In addition, the surface is coated to prevent oil coking. Hence, the remaining oil can be further reduced and coking can be less subject to be produced. Thereby, deterioration in strength of the piston caused by the coking can be prevented. Therefore, the piston for an internal combustion engine, which can easily respond to increased engine power can be obtained at a low cost.

Note that, the surface roughness is a roughness of a metal surface of the piston before being surface-coated.

According to an aspect of the invention of claim 4, the surface coating is a thin layer of the self-cleaning catalyst. Hence, the coking oil can be oxidized to be discharged as CO₂ so as not to remain on the surface. In addition, the surface coating is formed as the thin layer, so that the decrease in the coefficient of heat transfer can be reduced.

According to an aspect of the invention of claim 5, the surface coating is a thin layer of the porcelain enamel coating. Hence, the surface can be smoother, so that coking oil is less subject to remain. Further, by forming as the thin layer, the decrease in the coefficient of heat transfer can be reduced.

According to an aspect of the invention of claim 6, the surface coating is a thin layer of polysilazane-silica coating. Hence, the surface coating can be an extremely thin film coating. Thereby, the decrease in the coefficient of heat transfer can be reduced more reliably and the surface can be further smoother such that coking oil is less subject to remain.

### BRIEF DESCRIPTION OF DRAWINGS

FIG. 1 is a side cross section showing an arrangement of a piston for an internal combustion engine and a piston-cooling system of a first prior art example;

FIG. 2 is a view when seen in the direction of arrow X of FIG. 1;

FIG. 3 is a side cross section showing an arrangement of a piston of a second prior art example;

FIG. 4 is a side cross section showing an integral casting piston head according to a first embodiment of the present invention;

FIG. 5 is a side cross section showing an articulated piston head according to the first embodiment;

FIG. 6 is a cross section according to a second embodiment;

FIG. 7 is a cross section according to a third embodiment; and

FIG. 8 shows structural formulae for explaining a forth embodiment.

### EXPLANATION OF CODES

1, 30 : piston; 10, 35: combustion chamber; 10a, 35a: rear surface; 11: cooling cavity; 11a, 36a: inner wall; 36: cooling groove; 50: thin layer of self-cleaning catalyst; 60: thin layer of porcelain enamel coating

### BEST MODE FOR CARRYING OUT THE INVENTION

Embodiments of the present invention will be described below with reference to the accompanying drawings.

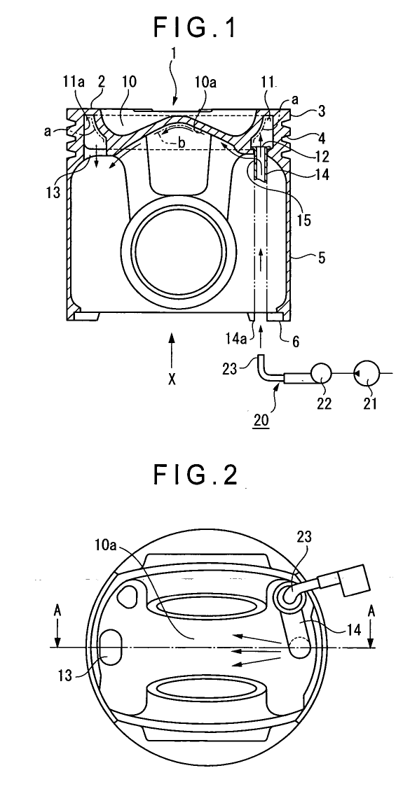

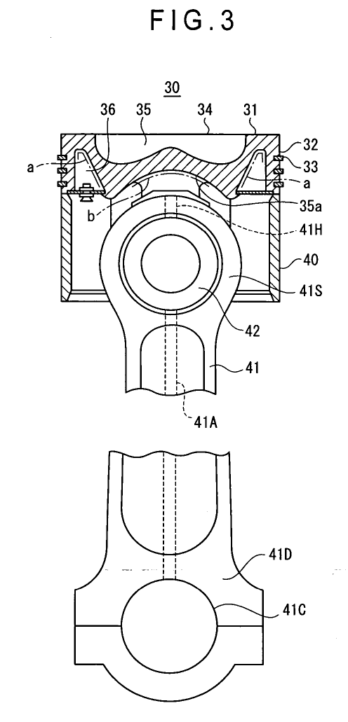

Note that, since a piston of each embodiment is different only in one portion from conventional pistons shown in FIGS. 1 and 3 and the shape and structure of the pistons are common, reference numerals used in FIGS. 1 and 3 are also used in describing the embodiments.

### First Embodiment

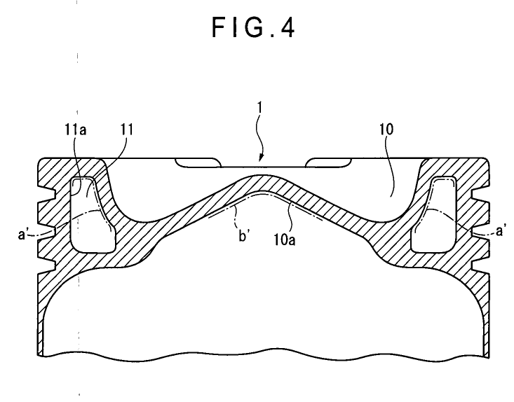

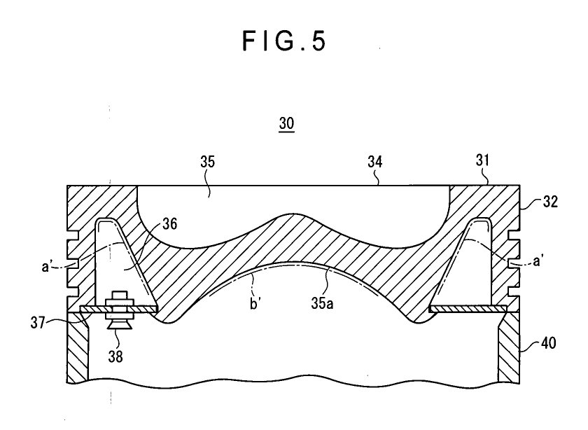

FIG. 4 is a side cross section showing an integral casting piston head according to a first embodiment of the present invention, and FIG. 5 is a side cross section showing an articulated piston head.

According to the embodiment, in FIG. 4, surface roughnesses of a rear surface 10a of a combustion chamber 10 and an inner wall 11a of a cooling cavity 11 of a piston 1 are 6.3 S. While in FIG. 5, surface roughnesses of a rear surface 35a of a combustion chamber 35 and an inner wall 36a of a cooling groove 36 of an articulated piston 30 are equal to or less than 6.3 S. Specifically, at least surface roughnesses of areas a′ and b′ indicated by chain double-dashed lines shown in FIGS. 4 and 5 are equal to or less than 6.3 S. The areas a′ and b′ indicated by the chain double-dashed lines respectively correspond to areas a and b indicated by chain double-dashed lines in FIGS. 1 and 3.

However, depending on the degree of an increase in temperature of the pistons 1 and 30, only the surface roughness of the rear surfaces 10a and 35a of the combustion chambers 10 and 35 may be equal to or less than 6.3 S, or only the surface roughness of the inner wall 11a of the cooling cavity 11 and the inner wall 36a of the cooling groove 36 may be equal to or less than 6.3 S.

Herein, the surface roughness is a maximum height Rz (JIS B 0601-2001) defined by the JIS (Japan Industrial Standard), and the expression of “equal to or less than 6.3 S” in the present embodiment means that the maximum height Rz is equal to or less than 6.3 pin.

To set the surface roughness equal to or less than 6.3 S, a casting surface after casting (in case of the piston 1) or a surface after forging (in case of the piston 30) may be processed by a method such as shot peening, sandblasting, liquid honing, grinding and machining using a machine tool including a lathe and a milling machine. When manufacturing by casting, the casting may be performed by a precision casting process. The surface roughness may be finished to be equal to or less than 6.3 S by performing a process such as buffing, papering, lapping, chemical polishing, electrolytic polishing and the like.

### Second Embodiment

According to a second embodiment of the present invention, like the first embodiment, as for the piston 1, the surface roughness of the rear surface 10a of the combustion chamber 10 and/or the surface roughness of the inner wall 11a of the cooling cavity 11 are/is equal to or less than 6.3 S, while as for the piston 30, the surface roughness of the rear surface 35a of the combustion chamber 35 and/or the surface roughness of the inner wall 36a of the cooling groove 36 are/is equal to or less than 6.3 S. These areas of which surface roughness is set to be equal to or less than 6.3 S are surface-coated to prevent oil coking.

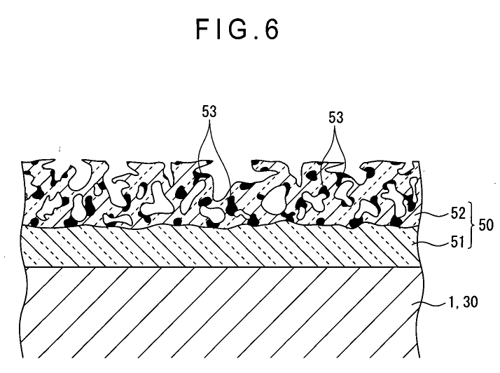

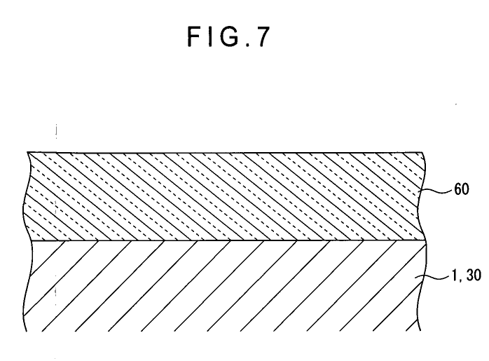

The surface coating in the present embodiment is a thin layer 50 of a self-cleaning catalyst shown in FIG. 6.

The thin layer 50 of the self-cleaning catalyst includes a catalyst, a heat-resistant bonding material (frit) and a porous (matte) forming material and has a function of flamelessly oxidizing and burning remaining oil by catalytic action into vapor and carbon dioxide. And when the engine is in operation and the pistons 1 and 30 are normally and continuously cooled by oil, an absolute amount of the oil being fed is large, so that the oil is mainly used for cooling rather than being oxidized and burnt by catalytic reaction. On the other hand, when the engine is stopped and the pistons 1 and 30 are also stopped, the absolute amount of the residual oil remaining on the surfaces becomes very small as compared with that when being cooled, so that the remaining oil is not used for cooling but is oxidized and burnt by catalytic reaction so as to be removed off the thin layer 50, thereby preventing coking.

As shown in FIG. 6, the thin layer 50 of the self-cleaning catalyst includes: a basecoat layer 51 of porcelain enamel composition formed on a metal surface of the pistons 1 and 30; and a catalytic layer 52 that is porous, porcelain-clad composition formed on the basecoat layer 51, the catalytic layer 52 supporting a catalyst 53. A thickness of the thin layer 50 is appropriately determined with consideration of affects that the decease in the coefficient of heat transfer gives on cooling effect of oil. Note that, a corrosion-resistant layer by an aluminizing process may be optionally provided between the metal surface and the basecoat layer 51.

As a usable catalyst, γ-MnO₂ and Zn−Mn ferrite for oxidation and α-Al₂O₃ and zeolite (aluminosilicate) for decomposition can be exemplified, all being used in a fine powder form.

As a heat-resistant bonding material for porcelain enamel, a low-temperature porcelain enamel type that is a synthetic composition made using, for example, SiO₂, B₂O₃, NaO, K₂O, Li₂O, CaO, and Al₂O₃ and can be fired at a low temperature of 580 degrees C. or less, can be exemplified with consideration of a softening temperature of the material of the pistons 1 and 30.

The thin layer 50 is formed by performing two coatings and one firing. Specifically, firstly the pistons 1 and 30 are degreased and washed, and the milled heat-resistant bonding material for base-coating is applied to a to-be-coated portion and dried with a far infrared ray of an infrared wavelength of 3 to 30 μm. Then, the catalyst and the heat-resistant bonding material that are mixed and milled is applied on the base-coated heat-resistant bonding material and dried with the far infrared ray in the same manner. Subsequently, after being applied with staple composition, the whole is burnt off to obtain the thin layer 50 including the basecoat layer 51 and the catalytic layer 52.

### Third Embodiment

According to a third embodiment of the present invention, as shown in FIG. 7, as the surface coating, a thin layer 60 of porcelain enamel coating not including a catalyst is alternatively used for the thin layer 50 of the self-cleaning catalyst of the second embodiment. The thin layer 60 is formed by a single layer of porcelain enamel not including a catalyst. The composition of the porcelain enamel may be the same as that of the heat-resistant bonding material of the second embodiment, but may be another composition generally used for porcelain enamel finishing of low-temperature porcelain enamel type. A thickness of the thin layer 60 is determined with consideration of its affects on the cooling effect, but is approximately 2 to 1000 μm.

### Forth Embodiment

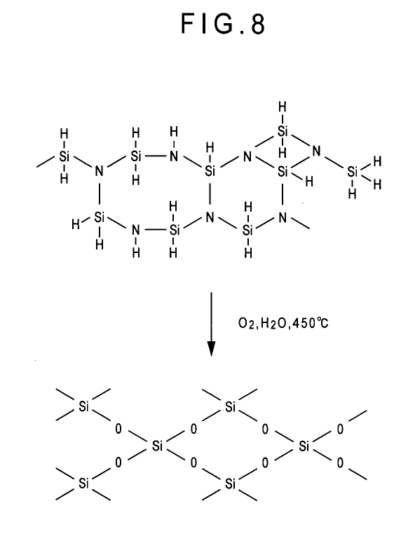

According to a forth embodiment of the present invention, a thin layer of polysilazane-silica coating is employed as the surface coating. The portion where the thin layer is to be formed is the same as that of the second and third embodiments. The thin layer is formed to be extremely thin as a single layer of approximately 0.1 to 1.0 μm. As shown in FIG. 8, the thin layer is a fine and high-purity silica layer (amorphous SiO₂) obtained by using an organic solvent of polysilazane of which basic unit is SiH₂NH and by burning at about 450 degrees C. in the atmospheric air or vapor-containing atmosphere to allow reaction with moisture and oxygen.

The coating material of polysilazane is available from Clariant (Japan) K.K. The polysilazane may be applied in any method such as spraying, hand-rubbing with a waste cloth, flow coating, roll coating, and the like. By employing the polysilazane-silica coating, a silica layer that is ceramic, extremely hard and thin and smooth can be formed, so that the oil can be effectively prevented from remaining, and coking can be reliably avoided.

It is to be noted that the scope of the present invention is not limited to the above-mentioned embodiments but includes various improvements and variations as long as an object of the present invention can be achieved. Concretely, for instance, in the integrated casting piston 1 shown in FIG. 1, 2 and 4, the rear surface 10a of the combustion chamber 10 may be cooled by the oil flowing in the connecting rod like the articulated piston 30 shown in FIG. 3. Alternatively, the rear surface 35a of the combustion chamber 35 in the piston 30 may be cooled by the oil injected from the guide pipe via the cooling nozzle.

As for the cooling nozzle and the guide pipe, two pairs thereof may be provided for one piston. In this case, one pair may be used for injecting the oil toward the cooling cavity and the cooling grooves of the combustion chamber on the peripheral portion side, while the other pair may be used for injecting the oil toward the rear surface of the combustion chamber.

In the second, third and forth embodiments, the surface roughness of the to-be-coated portion is equal to or less than 6.3 S. However, the surface roughness may be larger than 6.3 S in the inventions of claims 4, 5 and 6 not referring to claim 3 of the present invention (that is, when referring only to claim 2). Even when the surface roughness is larger than 6.3 S, the oil is less subject to remain and coking can be appropriately prevented owing to the surface coating. Still, the surface roughness of 6.3 S or less can more reliably and more effectively prevent the remain of the oil.

Hereinabove, best modes and methods for carrying out the present invention have been disclosed, but the present invention is not limited thereto. In other words, although the present invention has been illustrated in the figures and explained mainly in relation with the specific embodiments, it will be obvious to those skilled in the art that various changes may be made to the above-described embodiments in terms of profile, quantity and other details without departing from the scope and technical idea of the present invention.

Therefore, the description limiting the shapes and the materials disclosed above is intended to be illustrative for easier understanding and not to limit the invention, hence the present invention includes the description using a name of the component without a part of or all of the limitation on the shape and the material etc.

### INDUSTRIAL APPLICABILITY

The present invention can be utilized for any piston that is used for an internal combustion engine such as a diesel engine and a gasoline engine.

1. A piston for an internal combustion engine which is cooled by oil, the piston comprising:
a combustion chamber that is formed in a recessed shape on a top surface of the piston and has a rear surface cooled by the oil; and
a circular cooling cavity or a circular cooling groove which is provided on a peripheral portion of the combustion chamber, an inner wall of the cavity or the groove being cooled by the oil, wherein
a surface roughness of at least one of the rear surface of the combustion chamber, the inner wall of the cavity and the inner wall of the groove is equal to or less than 6.3 S.

2. A piston for an internal combustion engine which is cooled by oil, the piston comprising:
a combustion chamber that is formed in a recessed shape on a top surface of the piston and has a rear surface cooled by the oil; and
a circular cooling cavity or a circular cooling groove which is provided on a peripheral portion of the combustion chamber, an inner wall of the cavity or the groove being cooled by the oil, wherein
at least one of the rear surface of the combustion chamber, the inner wall of the cavity and the inner wall of the groove is surface-coated to prevent oil coking.

3. A piston for an internal combustion engine which is cooled by oil, the piston comprising:
a combustion chamber that is formed in a recessed shape on a top surface of the piston and has a rear surface cooled by the oil; and
a circular cooling cavity or a circular cooling groove which is provided on a peripheral portion of the combustion chamber, an inner wall of the cavity or the groove being cooled by the oil, wherein
a surface roughness of at least one of the rear surface of the combustion chamber, the inner wall of the cavity and the inner wall of the groove is equal to or less than 6.3 S, and
the at least one of the rear surface of the combustion chamber, the inner wall of the cavity and the inner wall of the groove is surface-coated to prevent oil coking.

4. The piston for the internal combustion engine according to claim 2, wherein the surface coating is a thin layer of a self-cleaning catalyst.

5. The piston for the internal combustion engine according to claim 2, wherein the surface coating is a thin layer of a porcelain enamel coating.

6. The piston for the internal combustion engine according to claim 2, wherein the surface coating is a thin layer of a polysilazane silica coating.

7. The piston for the internal combustion engine according to claim 3, wherein the surface coating is a thin layer of a self-cleaning catalyst.

8. The piston for the internal combustion engine according to claim 3, wherein the surface coating is a thin layer of a porcelain enamel coating.

9. The piston for the internal combustion engine according to claim 3, wherein the surface coating is a thin layer of a polysilazane silica coating.
